(19) United States
(12) Patent Application Publication
(10) Pub. No.: US 2014/0060674 A1
(43) Pub. Date: Mar. 6, 2014

(54) ADD-ON CLEANING SOLUTION RECYCLING APPARATUS

(71) Applicant: Rudy Publ, Glendale Heights, IL (US)

(72) Inventor: Rudy Publ, Glendale Heights, IL (US)

(21) Appl. No.: 14/015,532

(22) Filed: Aug. 30, 2013

Related U.S. Application Data
(60) Provisional application No. 61/695,946, filed on Aug. 31, 2012.

(51) Int. Cl. B08B 3/14

(52) U.S. Cl. CPC B08B 3/14
USPC 137/544; 29/428

(57) ABSTRACT

A cleaning solution recycling apparatus includes a separation device that is adapted to be fluidly connected to a tank of cleaning solution and an inlet conduit fluidly connected to the tank of cleaning solution. The inlet conduit has a first end that is fluidly connected to the tank of cleaning solution and a second end fluidly connected to the separation device. The first end is positioned at a height lower than the height of the second end such that when the level of cleaning solution in the tank is above a predetermined level, cleaning solution flows into the separation device.

### RELATED APPLICATION

This application claims the benefit of and priority from U.S. Provisional Application Ser. No. 61/695,946, filed Aug. 31, 2012, titled Cleaning Solution Recycling Apparatus, which is hereby fully incorporated herein by reference.

### BACKGROUND

Automotive, industrial, and other commercial cleaning of parts often uses cleaning solutions that aid in the removal of oil, grease, dirt, and other debris from mechanical parts. During the cleaning process, the oil, grease, dirt and other debris that is removed from the cleaned part becomes mixed with the cleaning solution resulting in contaminated cleaning solution. Some of these contaminants are of a size or type that they will self-separate from the cleaning solution by gravity and sink to the bottom of the cleaning solution tank. Other contaminants, however, do not self-separate and the contaminants remain mixed with, dissolved or suspended in the cleaning solution. This contamination can reduce the effectiveness of the cleaning solution as well as re-introduce contaminants to the parts intended for cleaning as well as to other components of a parts washer assembly. One way of addressing the contamination of cleaning solutions is to simply replace the contaminated cleaning solution with new cleaning solution. The replacement of cleaning solution, however, is costly and requires interruption of use of a parts washer assembly.

Instead of replacing cleaning solution and in order to reduce the frequency at which the cleaning solution needs to be replaced, the cleaning solution can be cleaned by removing contaminants, dissolved, from a contaminated cleaning solution mixture. One way of accomplishing this is to add a cleaning solution recycling apparatus to a parts washer whereby contaminants, dissolved, are removed from the cleaning solution. One example of a cleaning solution recycling apparatus is a cleaning solution distiller. In general, known cleaning solution distillers are large, complicated, and expensive devices. There exists a need in the marketplace for smaller, inexpensive, and less complicated cleaning solution recycling assemblies. Such devices, such as the examples of the present disclosure, require less space and maintenance than other cleaning solution recycling assemblies and are less expensive.

### BRIEF SUMMARY

In one example, a cleaning solution recycling apparatus includes a separation device that is adapted to be fluidly connected to a tank of cleaning solution and an inlet conduit fluidly connected to the tank of cleaning solution. The inlet conduit has a first end that is fluidly connected to the tank of cleaning solution and a second end fluidly connected to the separation device. The first end is positioned at a height lower than the height of the second end such that when the level of cleaning solution in the tank is above a predetermined level, cleaning solution flows into the separation device.

In another example, the cleaning solution recycling apparatus includes an inlet valve and a return valve that are operably connected to a control unit that controls the operation of the separation device and the opening and closing of the inlet valve and the return valve.

### BRIEF DESCRIPTION OF THE DRAWINGS

The following disclosure as a whole may be best understood by reference to the provided detailed description when read in conjunction with the accompanying drawings, drawing description, abstract, background, and associated headings. Identical reference numerals when found on different figures identify the same elements or a functionally equivalent element.

FIG. 1 is a schematic representation of a cleaning solution recycling apparatus connected to a parts washer assembly according to one embodiment of the present disclosure.

FIG. 2 is a schematic representation of a cleaning solution recycling apparatus according another embodiment of the present disclosure.

FIG. 3 is schematic functional block diagram of a distillation device of another embodiment of the present disclosure.

FIG. 4 is a schematic representation of a cleaning solution recycling apparatus according to another embodiment of the present disclosure.

### DETAILED DESCRIPTION

The present invention is not limited to the particular details of the apparatus depicted, and other modifications and applications may be contemplated. Further changes may be made in the device without departing from the true spirit of the scope of the invention herein involved. It is intended, therefore, that the subject matter in this disclosure should be interpreted as illustrative, not in a limiting sense.

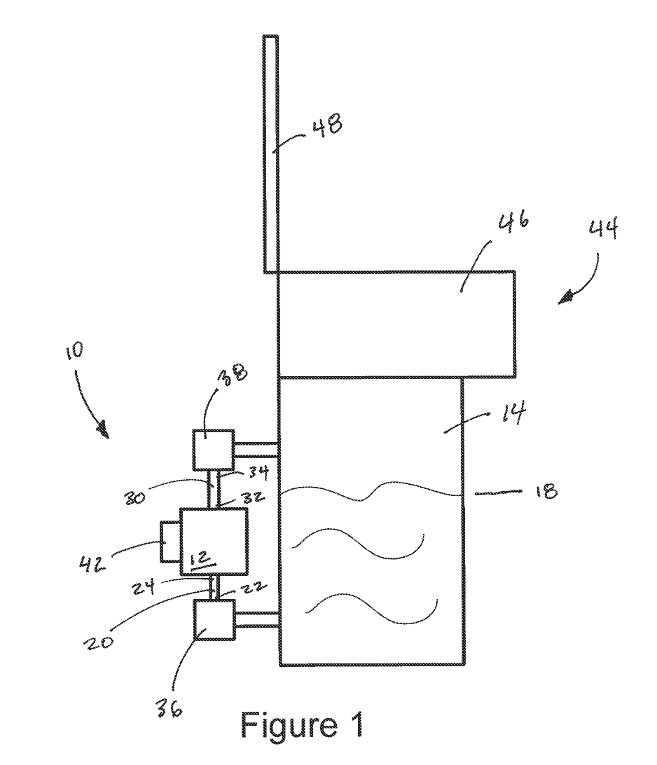

FIG. 1 depicts one embodiment of a cleaning solution recycling apparatus 10 installed on a parts washer assembly 44. The parts washer assembly 44 includes a tank for holding cleaning solution 14, a part washing sink 46 with lid 48. The parts washer assembly 44 may otherwise be configured similar to other parts washer assemblies as described in U.S. Pat. Nos. 8,470,138; 8,016,946; 7,740,711; 7,040,161; 6,874,512; 5,720,308; 4,823,820; 4,261,378; 4,049,551, U.S. application Ser. No. 13/033,286 and other similar patents and applications commonly owned, all of which are hereby fully incorporated by reference herein. The cleaning solution recycling apparatus can be used with various parts washer assemblies and other devices that utilize a tank of cleaning solution that may become contaminated. Cleaning solution recycling apparatus 10, in one example, includes inlet conduit 20, separation device 12, and return conduit 30. Cleaning solution recycling apparatus 10 may additionally include inlet valve 36, return valve 38, and control unit 42.

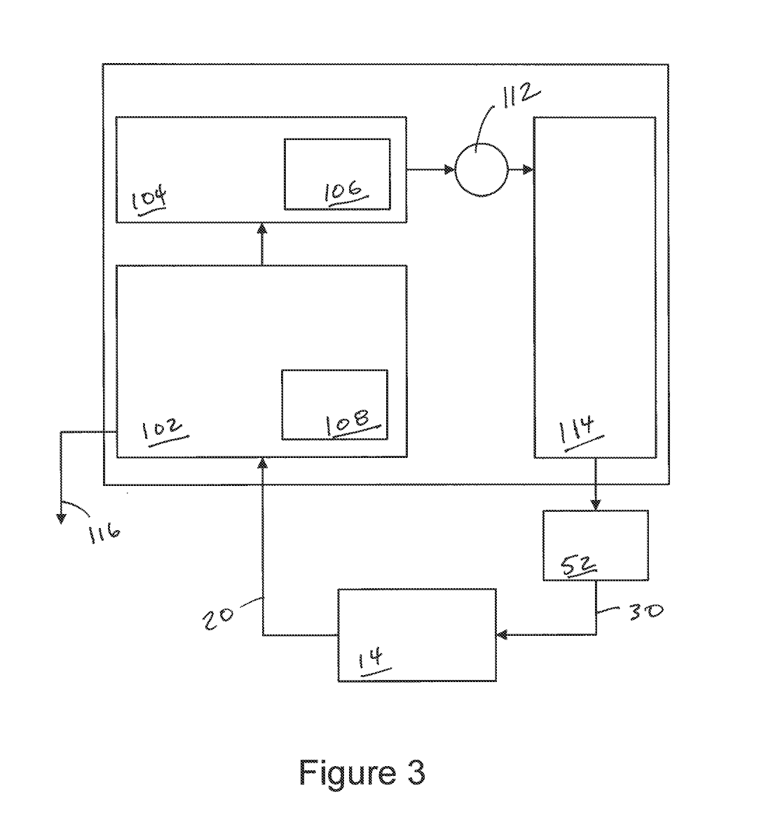

Separation device 12 can be any device that removes a portion of the contaminants that may become mixed with a cleaning solution. In one example, as shown by FIG. 3, separation device 12 is a distillation device 100. Distillation device 100 may include a distillation chamber 102, a condenser 104, a fan 106, a heater 108, a pump 112, a holding chamber 114, and a discharge port 116.

Distillation chamber 102, in one example, is a volume that functions to hold the cleaning solution and contaminant mixture. A cleaning solution used to degrease or otherwise clean objects such as automotive parts, typically has a boiling point lower than that of the contaminants that may become mixed with the cleaning solution during the cleaning of parts. One such type of cleaning solution is a cleaning solvent mineral spirits, etc. or the like. A cleaning solvent may be acetone based with a boiling point of only 133 degrees Fahrenheit. The cleaning solution recycling apparatus and present disclosure, however, can be used with other types of cleaning solutions such as aqueous cleaning solutions and others known to those of ordinary skill in the art. Utilizing the disparity between the boiling points of the cleaning solution and the contaminants, heater 108 heats the contaminated cleaning solution mixture in distillate chamber 102 to a temperature at which the cleaning solution turns to vapor and separates from the liquid cleaning solution mixture.

The cleaning solution vapor, in this example, then moves from the distillation chamber 102 to condenser 104 wherein the vapor cools and returns to liquid state. This cooling can be assisted by fan 106 that can move air over the condenser and more rapidly cool cleaning solution vapor. The distilled liquid cleaning solution then moves to holding chamber 114. After this process, substantially purified cleaning solution is left in holding chamber 114 and is ready for return to a cleaning solution tank 14 for re-use. As seen in FIG. 3, in this example, a pump 112 is included in the distillation device 100. Pump 112 facilitates movement of the cleaning solution vapor through the system and additionally can facilitate the return of the liquid cleaning solution in holding chamber 114 to a tank of a parts washer assembly. Additionally, pump 112 can introduce a vacuum into distillation chamber 102 such that the reduced pressure of distillation chamber 102 can have the effect of reducing the boiling point of the cleaning solution in the cleaning solution mixture such that separation of cleaning solution vapor from the cleaning solution mixture can be achieved at a lower temperature.

Distillation device 100 also includes discharge port 116. Discharge port 116 is the element of distillation device 100 through which contaminants can be removed. After distillation of the cleaning solution mixture, the cleaning solution is separated and removed for further cleaning while contaminants remain. Discharge port 116 can be periodically opened and contaminants can be removed. Examples of discharge port 116 include a threaded hole with mating plug, a one-way valve, a gate or ball valve, and a removable panel. Other configurations known to one of ordinary skill in the art can also be used.

As previously described, separation device 12 is a distillation device. However, other devices can be used that separate at least a portion of the contaminants from a contaminated cleaning solution mixture. Another example device that can be used is a filtration device in which a cleaning solution mixture is pumped through a filter whereby contaminants are separated from the cleaning solution mixture. Additionally, aqueous chemistry processing may be used as well. Other methods or types of separating processes can be used as are known to those of ordinary skill in the art.

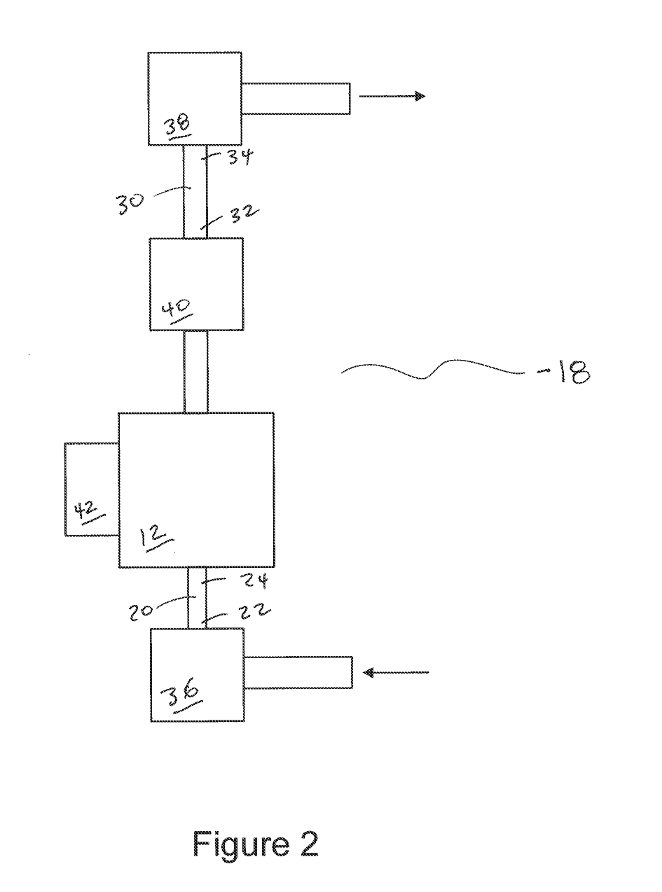

Referring back to FIGS. 1 and 2, the arrangement and other components of a cleaning solution recycling apparatus are shown. As shown in one example, separation device 12 is fluidly connected to tank 14 by inlet conduit 20 and return conduit 30. Inlet conduit 20 and return conduit 30 can be any suitable material and configuration to deliver and return cleaning solution to and from separation device 12. A first end 22 of inlet conduit 20 fluidly connects separation device 12 to tank 14. A second end 24 of inlet conduit 20 is connected to the separation device. While inlet conduit 12, in the example shown in FIG. 1, is physically separated from the tank 14 by inlet valve 36, many different configurations of the cleaning solution recycling apparatus 10 can be used without departing from the spirit of the present disclosure. Interim fittings, flow devices, and other components can be used as are known to those of ordinary skill in the art.

In one embodiment, first end 22 of inlet conduit 20 is configured such that first end 22 is located at a height that is below cleaning solution level 18 of tank 14. Further, second end 24 is positioned at a height that is higher than the height of first end 22. This arrangement provides for the flow of cleaning solution into separation device 12 through inlet conduit 20 when cleaning solution level 18 is above a predetermined height. As can be appreciated, a volume of cleaning solution above first end 22 of inlet conduit 20 creates head pressure such that cleaning solution will flow into inlet conduit 20 and through second end 24 of inlet conduit 20 even though second end 24 of inlet conduit 20 may be above first end 22 of inlet conduit 20. The pressure differential between first end 22 and second end 24 of inlet conduit 20 allows cleaning solution to be transferred from tank 14 to cleaning solution recycling assembly 10 without the aid of a pump or other device, thereby simplifying the complexity and expense.

In this example configuration, cleaning solution may flow into separation device 12 without the need for an additional pump or other mechanism. Contaminants can then be removed from the contaminated cleaning solution mixture via any of the methods or devices previously described. Return conduit 30 fluidly connects separation device 12 to tank 14 for the return of cleaning solution, after the separation process, back to tank 14. As shown in FIG. 1, a fourth end 34 of return conduit 30 may be configured such that the height of fourth end 34 is above cleaning solution level 18 of a volume of cleaning solution in tank 14. Other configurations, however, can be employed.

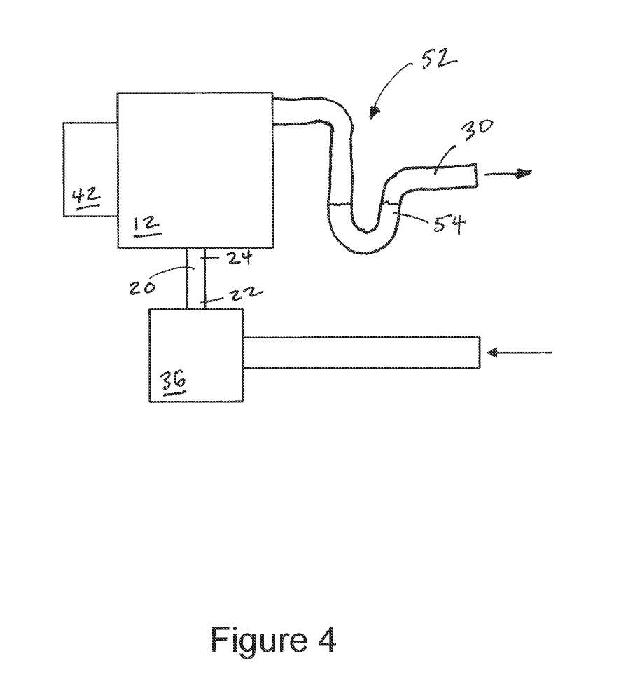

In one example, as shown in FIG. 4, accumulator 52 may be included in cleaning solution recycling apparatus 10. Accumulator 52 is an element that can collect liquid cleaning solution after it has been processed by separation device 12. In one example, cleaning solution vapor may exit separation device 12 and condense to liquid and collect in accumulator 52. In other examples, cleaning solution may already be in a liquid state upon reaching accumulator 52. In either case, accumulator 52, in one example, includes structure such that a volume of cleaning solution is positioned within accumulator 52 and upon reaching a certain volume or level of cleaning solution within accumulator 52, cleaning solution flows back into tank 14. One example configuration to this end, as shown in FIG. 4, is a p-trap configuration. As can be appreciated, as cleaning solution flows into accumulator 52 it fills the bottom of the loop. The volume of cleaning solution in the loop can remain in the accumulator and cleaning solution will only flow back into tank 14 if the level of cleaning solution rises to fill the return leg 54 of accumulator 52. The volume of cleaning solution that remains at the base loop of accumulator 52 can act as a barrier to prevent the transmission of odors or other vapors through return conduit 30 or other flow paths of cleaning solution recycling apparatus 10. Other configurations of accumulator 52 may also be used such as, but not limited to, a s-trap, j-trap, bottle trap, gully trap or the like. The accumulator is also advantageous in dealing with condenser failure/breakthrough by preventing the negative effects thereof; such as retaining odors, among other things.

As seen in FIGS. 1 and 2, cleaning solution recycling apparatus 10, in another example, can include inlet valve 36 and return valve 38. Inlet valve 36 is fluidly connected between tank 14 and separation device 12. The inlet valve 36 may be situated in any suitable position such that it can control (i.e. limit or permit) the flow of cleaning solution from tank 14 to separation device 12. Inlet valve 36 can be any suitable valve, such as but not limited to, a one-way valve, a ball valve, butterfly valve, globe valve, automatic or automated solenoid valve or gate valve. Additionally, inlet valve 36 can be manually or automatically actuated. Inlet valve 36 may also be connected to control unit 42 that facilitates or otherwise manages the actuation of inlet valve 36 through electronic, pneumatic of other means.

Return valve 38 fluidly connects separation device 12 to tank 14 and is configured to control the flow of separated cleaning solution from the separation device 12 back to tank 14. Return valve 38 can be one of the types of valves discussed above with respect to inlet valve 36 but additionally can be any suitable valve as known to one of ordinary skill in the art. Return valve 38 may also be connected to control unit 42 such it can be actuated or managed by control unit 42. Return valve 38, however, can also be provided with manual control or actuation. Valves 36 and 38 may also be interlocked or interconnected with control logic as described herein so as to provide coordinated control of the actuation thereof (i.e., opening, closing, throttling, pulse with modulation, etc. or the like).

Control unit 42 can be any suitable mechanism that can manage the different components of cleaning solution recycling apparatus 10. In one embodiment, control unit 42 is a programmable logic controller (PLC) and is electrically connected to the various components of cleaning solution recycling apparatus 10. Control unit 42 may also include any number of sensors such as, but not limited to, flow sensors, temperature sensors, pressure sensors, and the like. Control unit 42 may then actuate various valves, switch different components on and off, and vary the pressure or flow of cleaning solution through cleaning solution recycling apparatus 10. As shown, control unit 42 is mounted to a housing of separation device 10. Control unit 42, however, can be mounted to other portions of cleaning solution recycling apparatus or to other parts of washer assembly 44 for ease of access or use.

As shown in FIG. 2, cleaning solution recycling apparatus may additionally include odor mitigation cartridge 40. Odor mitigation cartridge can be any suitable component that removes objectionable odors that may be emitted from the cleaning solution, cleaning solution mixture, or the various chambers holding the cleaning solution during various stages of processing. Odor mitigation cartridge 40 can be an Iron Oxide filter cartridge but other suitable cartridges including suitable treatment media known to those of ordinary skill in the art can be used as well. As shown in one embodiment, odor mitigation cartridge is arranged between separation device 12 and return valve 38. Other configurations, such as positioning odor mitigation cartridge 40 between return valve 38 and tank 14 can also be used.

Cleaning solution recycling apparatus 10 can be provided in conjunction with a parts washer assembly 44 solvent vat, tank, or other device using cleaning solution that can become contaminated. Additionally, cleaning solution recycling apparatus 10 can be provided as a kit or add-on to such assemblies. A kit including any or all of the components of cleaning solution recycling apparatus 10 can be provided for installation onto a tank of cleaning solution. Additionally, parts washer assemblies can be provided in which the tanks on such assemblies are equipped with fittings or other attachment points such that a cleaning solution recycling apparatus can be easily installed onto the parts washer assembly.

A kit, such as the one described above, can be installed onto a parts washer or other cleaning device such that a cleaning solution recycling apparatus is fitted onto a tank of cleaning solution. One method for accomplishing this result is to connect a first end 22 of inlet conduit 20 to tank 14 of cleaning solution. First end 22 can be connected directly to tank 14 via a fitting or other connection device. The fitting can be a threaded fitting, a soldered fitting, a compression fitting, a quick-connect fitting or other fitting as know to one of ordinary skill in the art. First end 22 can also be connected to other interim components or conduits such that tank 14 is fluidly connected to inlet conduit 20. Second end 24 can then be connected to separation device 12. Similarly to the discussion above, second end 24 can be directly or indirectly connected to separation device 12 so long as inlet conduit 20 is fluidly connected to separation device 12. A fitting, as discussed above, can also be used to accomplish this connection.

In one example, the connection of first end 22 and second end 24 are configured with second end 24 above first end 22 and with first end 22 below a predetermined level of cleaning solution in tank 14. This arrangement, as discussed above, allows cleaning solution to flow from first end 22 to second end 24 in response to a pressure differential between first end 22 and second end 24. The installation of cleaning solution recycling apparatus 10 can continue with the connection of separation device 12 to inlet conduit 20. Return conduit 30 can then be installed for the return of cleaning solution to tank 14.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

We claim:

1. A cleaning solution recycling apparatus comprising:
a separation device adapted to be fluidly connected to a tank of cleaning solution, a volume of the cleaning solution in the tank defined by a cleaning solution level of the cleaning solution; and
an inlet conduit comprising a first end adapted to be fluidly connected to the tank and a second end fluidly connected to the separation device, the first end adapted to be disposed at a first height and said second end adapted to be disposed at a second height, wherein the first height is less than the second height and when the cleaning solution level is above the second height, cleaning solution flows into the separation device.

2. The cleaning solution recycling apparatus of claim 1 further comprising a return conduit comprising a third end connected to the separation device and a fourth end adapted to be fluidly connected to the tank and configured to return recycled cleaning solution from the separation device to the tank of cleaning solution.

3. The cleaning solution recycling apparatus of claim 1 further comprising an inlet valve fluidly connected to the inlet conduit and configured to operate in an open mode and a closed mode wherein when the valve operates in an open mode, cleaning solution flows into the separation device when the cleaning solution level is above a predetermined height.

4. The cleaning solution recycling apparatus of claim 1 further comprising a return valve fluidly connected to the return conduit and configured to operate in an open state and a closed state such that when the return valve is in the open state, cleaning solution is able to return to the tank of cleaning solution.

5. The cleaning solution recycling apparatus of claim 1 further comprising an odor mitigation cartridge fluidly connected to the separation device and configured to restrict the escape of objectionable odors from the separation device.

6. The cleaning solution recycling apparatus of claim 3 further comprising a control unit operably connected to the separation device and the inlet valve and configured to control the operation of the separation device and selection of the operation of the inlet valve between the open and the closed mode.

7. The cleaning solution recycling apparatus of claim 1 wherein the separation device is a distillation device.

8. The cleaning solution recycling apparatus of claim 1 wherein the separation device is a process aqueous chemistry device.

9. The cleaning solution recycling apparatus of claim 1 wherein the separation device is a filtration device.

10. The cleaning solution recycling apparatus of claim 1 that does not include a flow device to induce the flow of cleaning solution in the inlet conduit.

11. A method of installing a recycling apparatus on a tank for holding cleaning solution comprising:
fluidly connecting a first end of an inlet conduit to the tank for holding cleaning solution;
fluidly connecting a second end of the inlet conduit to a separator device;
wherein when a cleaning solution level of cleaning solution in the tank is above a second end of the inlet conduit, such that head pressure at the first end of the inlet conduit causes cleaning solution to flow into the separator device.

12. A cleaning solution tank comprising:
an inlet fitting configured to allow connection of an inlet conduit of a cleaning solution recycling apparatus; and
a return fitting located above the inlet fitting to allow connection of a return conduit of the cleaning solution recycling apparatus;
wherein cleaning solution flows through the inlet fitting, into the inlet conduit and to a separation device of the cleaning solution recycling apparatus when a cleaning solution level of cleaning solution in the tank is above a predetermined level.

13. The cleaning solution tank of claim 12 configured to be connected to a sink of a parts washer assembly.

14. The cleaning solution tank of claim 12 wherein the separation device is a distillation device.

15. The cleaning solution tank of claim 12 wherein the inlet fitting is an inlet valve.

16. The cleaning solution tank of claim 12 wherein the return fitting is a return valve.

17. The cleaning solution tank of claim 12 wherein the cleaning solution tank is a drum.

18. A cleaning solution recycling apparatus consisting essentially of:
a separation device adapted to be fluidly connected to a tank of cleaning solution, a volume of the cleaning solution in the tank defined by a cleaning solution level of the cleaning solution; and
an inlet conduit comprising a first end adapted to be fluidly connected to the tank and a second end fluidly connected to the separation device, the first end adapted to be disposed at a first height and said second end adapted to be disposed at a second height, wherein the first height is less than the second height and when the cleaning solution level is above the second height, cleaning solution flows into the separation device.

19. A cleaning solution recycling apparatus consisting of:
a separation device adapted to be fluidly connected to a tank of cleaning solution, a volume of the cleaning solution in the tank defined by a cleaning solution level of the cleaning solution; and
an inlet conduit comprising a first end adapted to be fluidly connected to the tank and a second end fluidly connected to the separation device, the first end adapted to be disposed at a first height and said second end adapted to be disposed at a second height, wherein the first height is less than the second height and when the cleaning solution level is above the second height, cleaning solution flows into the separation device.
